(19) United States
(12) Patent Application Publication
(10) Pub. No.: US 2009/0066136 A1
(43) Pub. Date: Mar. 12, 2009

(54) Adjustable Backrest Device

(76) Inventor: Ming-Hung Wen, Min-Shiung-Shiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/852,383

(22) Filed: Sep. 10, 2007

(51) Int. Cl. B60N 2/20

(52) U.S. Cl. 297/361.1

(57) ABSTRACT

The present invention relates to an adjustable backrest device, the backrest is divided into an upper recliner and a lower recliner, the lower end of the lower recliner is fixed to the backside of the seat portion, and the upper recliner and lower recliner are each included a pivotal connected portion for coupling to each other; a plural number of positioning apertures are disposed at the lower recliner and a retractable positioner is located at a predetermined area of upper recliner, when the upper recliner is swung to a desired angle of reclining, the positioiner can insert to the corresponding positioning aperture, so that the upper recliner can be adjusted and positioned in the desired angle as required by the user, therefore, the different reclining angles can be provided for the needs of the user so as to allow the user to efficiently stretch and comfort its back while reclining against the backrest.

### FIELD OF THE INVENTION

The present invention is of a chair with an upper recliner and a lower recliner, the upper recliner is pivotally coupled to the lower recliner and a positioning apparatus is utilized for positioning the upper recliner after angle adjustment performance.

### BACKGROUND OF THE INVENTION

Conventional office chairs are usually possessed with function of reclining adjustment, and regardless the structure of the function in anyway, said reclining adjustment is based on a different angle adjustment to the entire backrest of the chair, since the base structure for adjustment is disposed between backside of the seat and lower end of backrest, therefore, the user can rest its back on the backrest after the adjustment to the entire backrest to be in a desired angle.

However, the curve design of the backrest is in accordance with the back of the user for perfectly fit in order to well stretch the user's back, but actually, the bottom of the user can not completely stay close between the chair seat and backrest, so that the user's back is still in a forward arch shape while sitting on the chair, therefore, the user would still have a sore waist and an aching back under a long-term since its back can not be stretched effectively.

### SUMMARY OF THE INVENTION

In order to overcome said problem, the present invention utilized a method to have an upper recliner and a lower recliner for a backrest, the upper recliner is turned forward or backward by the force of the elastic members, and a plural number of positioning apertures is disposed at the lower recliner, in the meantime, a predetermined area of the upper recliner has a retractable positioner to be inserted into any of the positioning apertures.

Therefore, the function of the rotatable and positioned upper recliner of the present invention can be utilized to adjust the angle of the upper recliner independently, that is not only provide the user with different way of reclining but also further stretching the user's back outwardly, hence, the user's back can be extended with effective exercise and, moreover, the tiredness of the back and backbone can be reduced.

The present invention will become more fully understood from the detailed description given hereinbelow and the accompanying drawings which are given by way of illustration only, and thus are not limitative of the present invention, and wherein:

### BRIEF DESCRIPTION OF THE DRAWINGS

FIG. 1 is a side view of back of the present invention.

FIG. 2 is an exploded view of the present invention.

FIG. 3 is a side perspective view of the present invention.

FIG. 4 is an enlarged perspective view of the pivotal connected portion of the present invention.

FIG. 5 is a side view of the adjustment of the present invention.

### DETAILED DESCRIPTION OF THE INVENTION

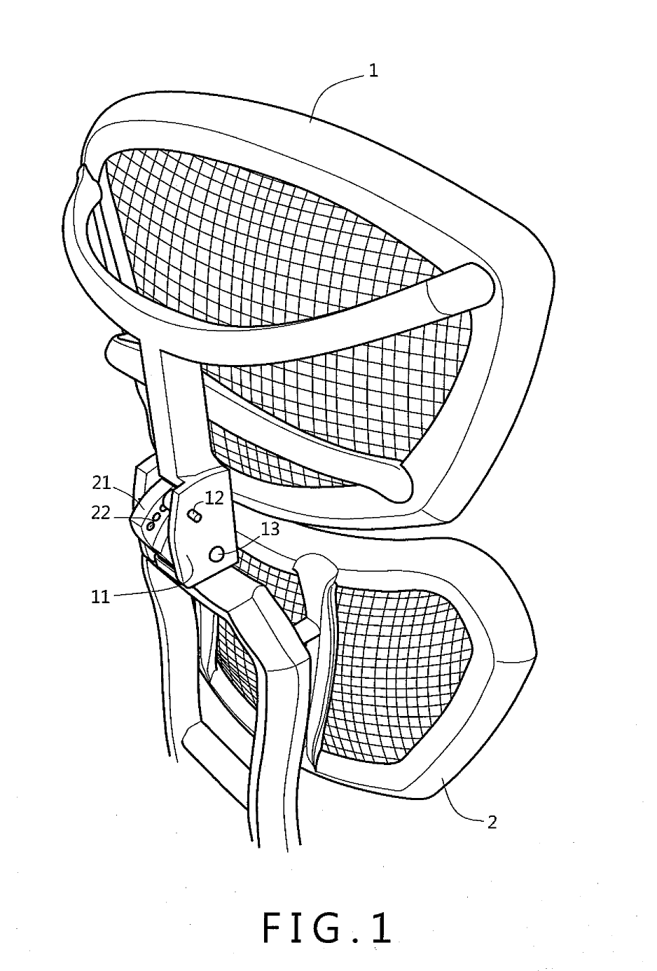

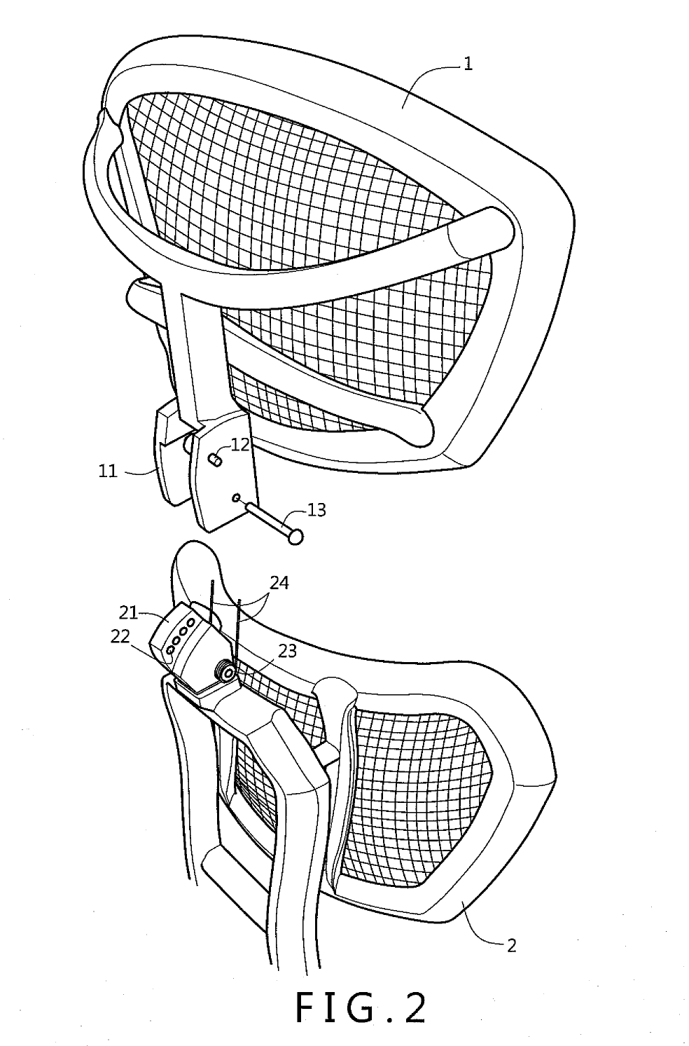

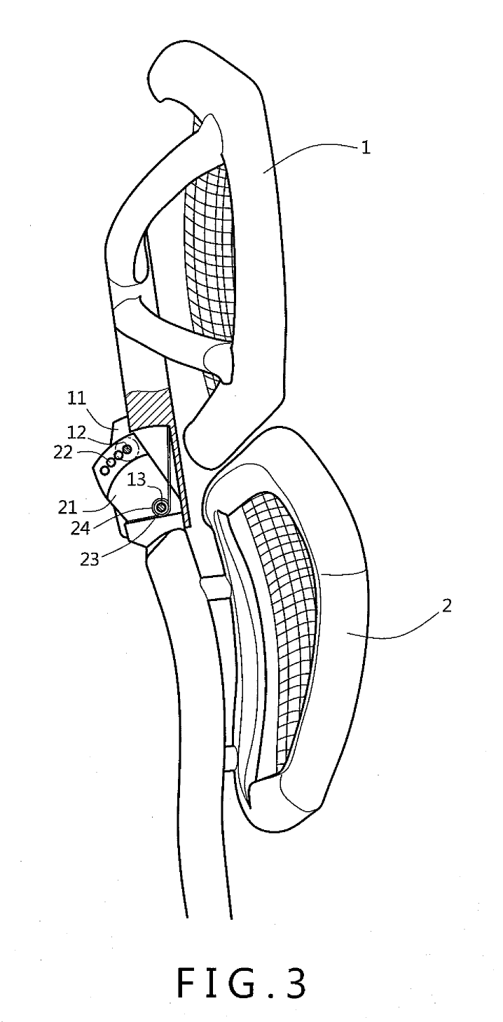

Referring to FIGS. 1, 2 and 3, the present invention includes an upper recliner 1 and a lower recliner 2, said recliners are pivotally connected to each other, and the lower end of the lower recliner 2 is extended coupled to a seating portion which accommodates the user, wherein:

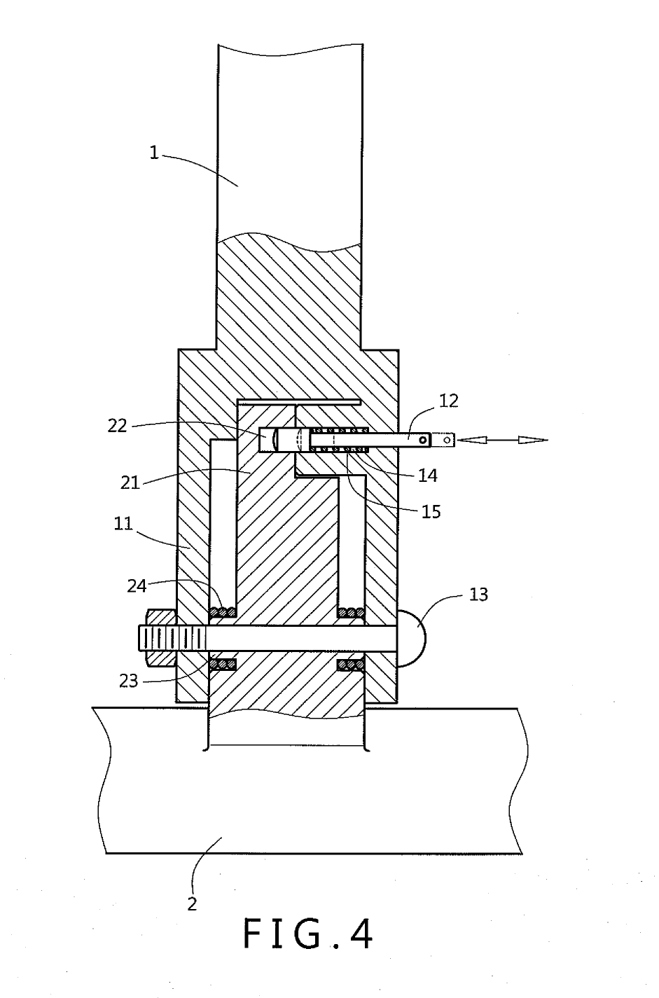

A pivotal fixed portion 11 is disposed between the upper recliner 1 and lower recliner 2, and a positioner 12 is passed through a predetermined area of the pivotal fixed portion 11, the positioner 12 is passed through a receiving hole 14 of the pivotal fixed portion 11 (as shown in FIG. 4), a spring 15 is arranged inside the receiving hole 14 for pushing the positioner 12 to be retracted, in the meantime, when the positioner 12 is passed through the pivotal fixed portion 11, one end of the positioner 12 is projected to connect with a wire (not shown) for the user to manipulate adjustment.

Also, a pivotal connected portion 21 is pivotally coupled between the lower recliner 2, so that the pivotal fixed portion 11 can be pivotally coupled to the upper recliner 1 by an axle rod 13, and the upper recliner can therefore be swung inwardly and outwardly, in addition, a plural number of positioning apertures 22 are disposed at the pivotal fixed portion 11 so as to allow the positioner 12 which is passed through of the upper recliner 11 to be received by any of the positioning apertures 22, furthermore, there are projections 23 each disposed on one side of the pivotal connected portion 21, and a elastic member 24 is mounted on one side of the projection 23; one end of the elastic member 24 is pressed against the pivotal connected portion 21, and the other end is against the pivotal fixed portion 11 of the upper recliner 1, therefore, the bounce of the ends of the elastic members can force the upper recliner 1 to swing forward automatically.

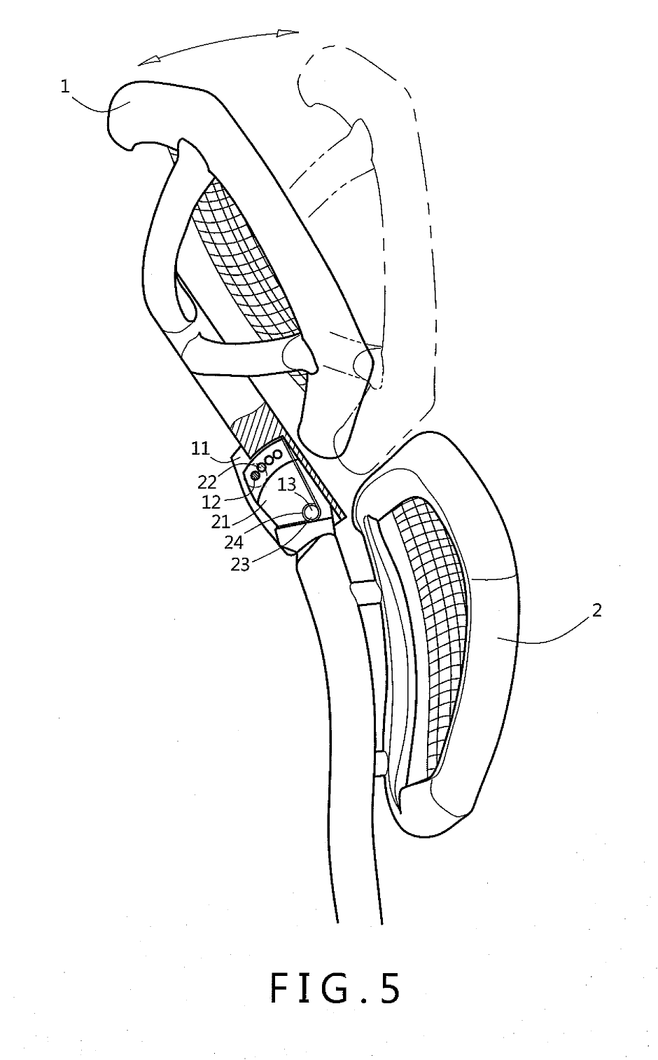

With reference to FIGS. 4 and 5, when the positioner 12 is pulled outwardly, its end exits from the positioning aperture 22, therefore, the upper recliner can be swung either forwardly or backward and the pulling force can be so released until reach an ideal angle of reclining, so that the positioner 12 can be received by the corresponding positioning aperture 22 and the upper recliner 1 is fixed.

Therefore, while the upper recliner stays still, the upper recliner 1 can be adjusted for different angles of reclining, also, when the lower recliner 2 is adjusted for different angles via a conventional adjusting base disposed and connected between its end and a seat portion of the chair, the upper recliner 1 can still be further adjusted in order to accomplish the goal of dual-adjustment; hence, when the user's back leans on the backrest of the chair, the upper recliner can be adjusted backwardly for laying down the back of the user so as to allow the back to be stretched backward and relax the muscle through effective stretch of the back; the user can feel relaxing and the weary is reduced while sitting.

What is claimed is:

1. an adjustable backrest device, comprising an upper recliner and a lower recliner, the upper recliner is pivotally connected to the lower recliner so as to allow the upper recliner to be swung forward or backward; at least one elastic member is disposed between the upper recliner and the lower recliner, the upper recliner can be swung forward and repositioned by the force of the elastic member, moreover, a positioning apparatus is further arranged for fixed position of the upper recliner.

2. An adjustable backrest device according to claim 1, wherein the positioning apparatus includes a positioner passed through the upper recliner and a plural number of positioning apertures are disposed at lower recliner in order to receive the positioner for passing through.

3. An adjustable backrest device according to claim 2, wherein the upper recliner and the lower recliner are each has a pivotal connected portion and the pivotal connected portions are pivotally coupled to each other, a projection is located each side of the pivotal connected portion of the lower recliner and is mounted by the elastic member; each end of the elastic member pushes against the upper recliner and the lower recliner.
